(19) United States
(12) Patent Application Publication
(10) Pub. No.: US 2004/0158816 A1
(43) Pub. Date: Aug. 12, 2004

(54) Personal data organizer software

(76) Inventors: Radha K.C. Pandipati, Montgomery Village, MD (US); Venkata Rao Mulpuri, Fairfax Station, VA (US)

Correspondence Address: Radha K.C. Pandipati, 19531 Desmet Place, Montgomery Village, MD, 20886, US

(21) Appl. No.: 10/749,842

(22) Filed: Dec. 31, 2003

Related U.S. Application Data
(60) Provisional application No. 60/438,178, filed on Jan. 7, 2003.

(51) Int. Cl. G06F 9/44

(52) U.S. Cl. 717/120; 717/116; 717/101

(57) ABSTRACT

In a single software package including a data entry interface that supports entry of data in multiple formats, all personal data of a user can be entered into a single personal data file of a single program. By the single software package, data is made easily accessible and transportable. The flexibility and convenience of data organization and retrieval afforded by the single software package may provide an improved quality of life for a user by freeing time and resources of the user.

This is a continuation of U.S. Patent Application Serial No. 60/438,178, filed on Jan. 7, 2003, which is a provisional patent application.

### BACKGROUND OF THE INVENTION

1. Field of the Invention

The present invention relates to a single software package for organizing all of one's personal data. More specifically, the present invention relates to a single personal data software package in which all of one's personal data may be entered, organized and stored in a single file and a single location.

2. Description of the Related Art

Invariably, most people try to organize all of their personal data at one time or another, so that when a need arises to access such data, one may do so, one hopes, with a minimal amount of effort and in a minimal amount of time. Unfortunately, people often end up spending a great deal of time attempting to organize their personal data, and often have little success in so doing. Nonetheless, such a goal is a worthy one, as organization of one's personal data may help one remember to pay bills on time, thereby avoiding late payment fees, renew policies and/or memberships on time, thereby avoiding lapses in coverage or benefits, and present loved one's with appropriate cards or gifts on particular, important dates, thereby avoiding embarrassment at having forgotten the occasion, or worse yet, the anger of the loved one. Of course, organization of one's personal data may provide countless other benefits, including reminding one to go to the doctor's or change the oil in the car, as well as providing easy access to receipts, legal documents, calendars, schedules, addresses and phone numbers, etc. The list could go on and on infinitum and still be different from person to person.

Despite the universal need, conventional software programs do not provide for the easy entry of a wide range of assorted data. Currently, to enter and store all of one's personal data, multiple software programs must be used, and even then certain types of data are difficult to enter due to a lack of proper tools. As a result, information is often entered and stored in different files, which, whether located in completely different software programs or different files of a same program, may become lost, and may not be easily linked with other data. The inability that exists between various software programs, and even between different files of a same software program, to communicate renders what might otherwise be extremely useful links virtually impossible. For example, linking phone numbers to corresponding addresses to directions to those addresses is not easy using word processing software.

Keeping a log of various lists, for sending Christmas cards and birthday greetings, for example, is not easy. Other data is even more cumbersome to store, such as all of the information from a passport. It is quite difficult to copy such information into a word processor for safekeeping, and a word processor will not remind one when their passport must be renewed.

Using currently available software, it is virtually impossible to pull together different pieces of information in the way they are needed, when they are needed. In fact, it is currently impossible to do a single search across all the various files in which one's personal data is stored. If not properly organized, people can spend hours, even days, attempting to locate certain information. Family communication and content management infrastructure—phone numbers, insurance details, home mortgage details, investments, assets, etc.—has become a critical part of every household. Unfortunately, technology has not kept up with needs. As a result, more and more people are suffering from unmanageable data/information storage and inadequate integration of various kinds of family data. To overcome all of the problems and deficiencies described above, a new single software package is desired.

### SUMMARY OF THE INVENTION

In an effort to overcome the problems mentioned above, the present invention provides a single personal data software package in which an entirety of one's personal data may be entered, stored and organized in a single software package to thereby eliminate the need for forced migrations, and to provide simplified access to and management of the personal data.

According to an embodiment of the present invention, there is provided a single personal data software package comprising a data entry interface that supports entry of data in multiple formats so that all personal data of a user can be entered into a single personal data file of a single program. According to a feature of the present invention, the single personal data software package further comprises a provision by which all of the entered personal data is organized and stored in the single personal data file of the single program. According to another feature of the present invention, the single personal data software package further comprises a provision by which organization, storage and retrieval of the entered data are governed by user-defined parameters. According to yet another feature of the present invention, the data entry interface of the single personal data software package supports data entered by scanning. According to a feature of the present invention, the single personal data software package further comprises pre-defined personal data categories including: a) contact information and directions, b) financial matters, c) reminders, and d) records. According to another feature of the present invention, each of the pre-defined personal data categories of the single software package further comprises pre-defined data sub-categories. According to yet another feature of the present invention, the sub-categories of the contact information and directions field include: names of individuals, schools, businesses, private and government agencies, institutions, organizations, facilities, or contact persons thereof; contact numbers including telephone numbers, cellular phone numbers and fax numbers related to the names; addresses including e-mail addresses, internet addresses, mailing addresses, and physical addresses related to the names and/or contact numbers; and directions to the physical addresses. According to a feature of the present invention, the single software package further comprises free data categories in which any information related to any contact information and directions entry may be entered, such as family information including names and ages of spouse and children, pertinent dates such as birthdays and anniversaries, and whether the contact information and directions entry should be included in any lists. According to another feature of the present invention, the lists of the single personal data organizer software package include a Christmas/New Year's greeting card list, birthday/wedding anniversary card list, invitation to event lists and other lists that are user defined. According to yet another feature of the present invention, the single software package supports directions entered by scanning. According to a feature of the present invention, the financial matters category of the single personal data organizer software package includes: (a) Assets/Investments: current and cash assets, stocks, mutual funds, government bonds, real estate properties, CDs, savings/checking accounts, partial or entire business ownerships, loans given to others, cash accumulated in whole life or universal life insurance policies, retirement related IRAs, 401Ks, jewelry, household appliances and furnishings and other possessions, (b) Payments: insurance (professional, health, dental, home, automobile, life, disability, travel, etc.) premiums, mortgage, real estate taxes, home owners association fees, car payments, credit card payments, membership dues, utilities (phone, electricity, gas, water, security alarm system, cable, cell phone), planned religious and charity contributions, alimony, child support, child/elder care, (c) Income: salary, interest, dividends, rental income, others, and (d) Expenses: household and automobile maintenance, food, gasoline, automobile repair, public/mass transportation, entertainment/vacation, charitable contributions. According to a feature of the present invention, the reminders category of the single personal data organizer software package includes: (a) Birthdays, anniversaries, holidays, special events, (b) Scheduled appointments for dental/medical/physical check-ups, automobile maintenance, c) Upcoming renewal dates for professional society memberships, passports, driver's license, automobile registration, club memberships, warranties, magazine subscriptions, household and appliance maintenance contracts, (d) Adult continuing education: course registration, conference and seminar registration, homework and project deadlines, and (e) Child related educational and extra-curricular activities such as SAT exam dates, summer camp registration, sports club registration, college/school application deadlines, scouts, projects, paper and homework due dates. According to another feature of the present invention, the records category of the single personal data organizer software package includes: (a) Wills, trusts, passports, house deeds, automobile ownership papers, drivers license, social security card and records, insurance policies, marriage and birth certificates, organ donor information, blood type, educational and professional certificates, CD certificates, data from receipts of jewelry and other valuables, warranties, (b) Scanned receipts and/or appraisal for jewelry, clothes, furniture, and other valuables, (c) Scanned photos of jewelry, passports, warranties, and other important documents, and (d) Voice/Video recordings. According to yet another feature of the present invention, the single personal data organizer software package further comprises provisions for easy access to and management of the entered personal data. According to yet another feature of the present invention, the single personal data organizer software package further comprises a provision by which an entirety of a user's personal data is searched by performing a single search. According to a feature of the present invention, the single personal data organizer software package further comprises a provision for creating new categories, sub-categories, and sub-sub-categories of personal data. According to another feature of the present invention, the single personal data organizer software package further comprises a provision to store a user's personal data on a CD or a diskette. According to yet feature of the present invention, the entered data of the single personal data organizer software package can be accessed and viewed in various formats including lists, tables, graphs and charts. According to a feature of the present invention, the various formats of the single personal data organizer software package include Christmas mailing address labels and birthday and wedding anniversary greeting card labels for birthdays and wedding anniversaries occurring in a particular month or any other pre-determined duration. According to another feature of the present invention, the various formats of the single personal data organizer software package are user defined by selection of categories, sub-categories and/or sub-sub-categories. According to yet another feature of the present invention, the single personal data organizer software package further comprises a provision to alert the user in advance of an event. According to a feature of the present invention, the event of the single personal data organizer software package includes any of a birthday, wedding anniversary, special event, real-estate tax payment due date, passport renewal, medical/physical check-up, dental check-up, auto maintenance, child related educational or extra-curricular activity such as SAT exam date, summer camp registration, sports club registration, college/school application deadline, scouts, due dates for projects, papers or homework, driver's license renewal, automobile registration renewals, membership renewals or other user defined events. According to another feature of the present invention, the single personal data organizer software package further comprises a provision by which multiple users are supported in a safe environment, wherein each user is provided an independent user ID and password. According to yet another feature of the present invention, the single personal data organizer software package further comprises a provision by which a user's personal data file is uploaded to a unique website to allow easy access to the personal data file from anywhere Internet access is provided. According to a feature of the present invention, the real estate of the single personal data organizer software package includes a primary residence, secondary or vacation homes, and investment properties. By the software of the present invention, all of one's personal data can be stored together in a single place, can be searched in its entirety with a single search, and can be uploaded to provide easy access thereto from any place on earth that internet access is provided.

Another feature of the present invention is to remind people of pending due dates. People often forget to renew their driver's license despite the fact that they carry it around with them all of the time, and may even refer to the expiration date occasionally. In today's busy world, it is difficult for people to unfailingly remember the myriad renewal and due dates that are incurred. People find it difficult to remember critical dates of many events beyond paying the monthly mortgage and utility bills. It would be highly beneficial and very convenient if a tool was available by which critical due dates for the next two, three, four, or more weeks could be printed by the touch of a button. That is, all of the dates would have been previously entered by a user, who could merely choose a time period and click a link to have any and all pending due dates from the chosen time period printed. The user could then post the printed information on refrigerator door or any other location frequently seen for reminding one about the due dates. By so doing, a user is less likely to miss an important due or renewal date.

Therefore, one's quality of life may be improved by the convenience provided by the software of the present invention.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 illustrates a typical view of Personal Data Organizer Software of the present invention as seen on a computer screen upon being opened;

FIG. 2 illustrates a typical view of the Personal Data Organizer Software as seen on a computer screen upon clicking a “File” menu of the software;

FIG. 3 illustrates a typical view of the Personal Data Organizer Software as seen on a computer screen upon clicking “Set-up New Account” under the “File” menu of the software;

FIG. 4 illustrates a typical view of the Personal Data Organizer Software as seen on a computer screen upon clicking “Open Existing Account” under the “File” menu of the software;

FIG. 5A illustrates a typical view of the Personal Data Organizer Software as seen on a computer screen upon clicking an existing account under the “Open Existing Account” menu of the software, data entry categories and data retrieve records;

FIGS. 5B to 5E illustrate typical views as seen on a computer screen showing sub-categories of each of the data entry categories shown in FIG. 5A upon clicking each data entry category of FIG. 5A;

FIG. 6 illustrates a typical view of a sub-sub-category as seen on a computer screen upon clicking on a sub-category of FIGS. 5B-5E;

FIG. 7 illustrates a typical view of the Personal Data Organizer Software as seen on a computer screen upon clicking on “Stocks” shown in FIG. 6;

FIG. 8A illustrates a typical view of the Personal Data Organizer Software as seen on a computer screen upon clicking on “Records” shown in FIG. 5A;

FIG. 8B illustrates a typical view of the Personal Data Organizer Software as seen on a computer screen upon clicking on “Phone List” shown in FIG. 8A;

FIG. 8C illustrates a typical view of the Personal Data Organizer Software as seen on a computer screen upon clicking on “Customize” shown in FIG. 8B;

FIGS. 8D thru 8H illustrate typical views as seen on a computer screen of customized records of the “Phone List” shown in FIG. 8B;

FIG. 81 illustrates a typical view of the personal data organizer software as seen on a computer screen upon clicking on “records” shown in FIG. 5A after creating customized records;

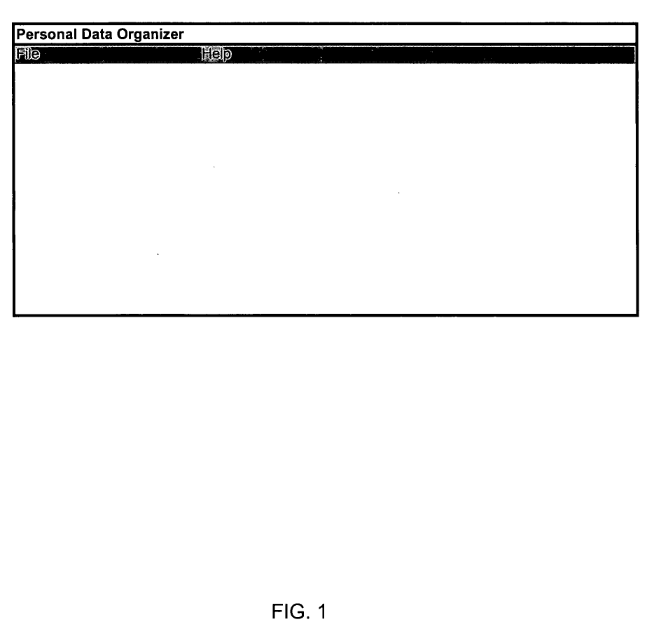

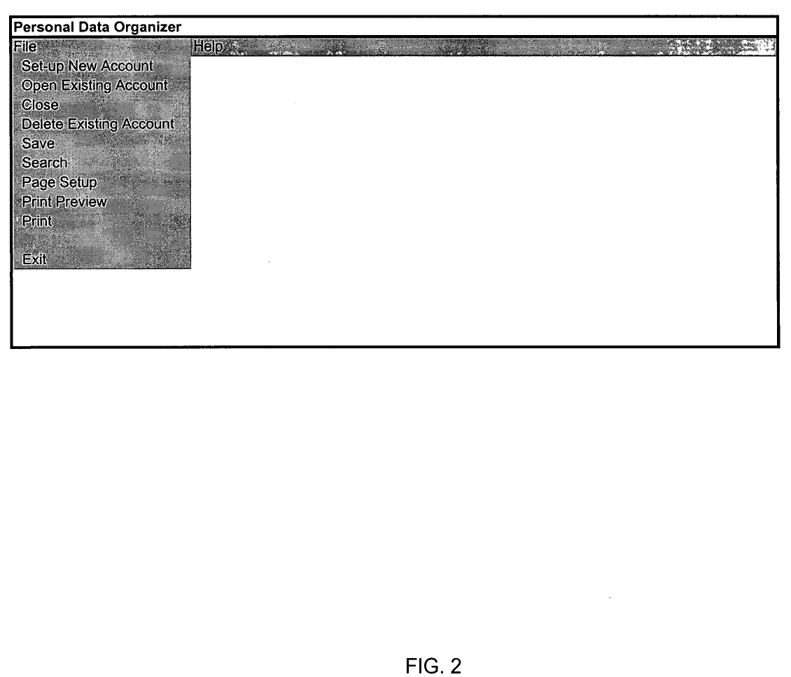

FIG. 9 illustrates a typical view of the Personal Data Organizer Software as seen on a computer screen upon clicking a “Help” menu of the software shown in FIG. 1.

### DETAILED DESCRIPTION OF THE INVENTION

The present invention will now be described more fully with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals in different drawings represent like elements.

A single software package according to an embodiment of the present invention allows a user to enter all of his/her personal data into one single file in one single location. Using the software concept of the present invention, one can access any of his/her personal data almost instantaneously. The single software package of the present invention accepts input data of different types and by different input means such as typing or transferring data into a document or spreadsheet, scanning data, etc., so that many different kinds of personal data may be input into a single file. Having various types of data in a single file facilitates easy access to the data, and may simplify a data entry process.

By the single software package of the present invention, all of one's personal data may be easily consolidated and electronically stored in one place. Further, the single software package of the present invention makes access to and transportability of all of a user's personal data very easy. For example, a user's entire personal data file having different forms of data may be searched using a single search. Providing key words allows one to search all of the data and compile data over selective range of dates in various formats. For example, selecting the tabular format containing “Investment Company” and “addresses” generates a list of organizations, addresses and phone numbers of all investments. If a user wants to compile a list of addresses of friends and family in one geographic location, the user may simply enter the name of the geographic location as a keyword and select the required format. In response, the software will list all addresses containing the keyword in alphabetical order. Further, by selecting the “addresses” category and entering the keyword “New Year,” a user is able to generate a list of names and addresses of people to whom the user wants to send New Years greetings. To generate a list of people whose birthdays fall in a particular month, a user merely selects the “addresses” category and enters the keywords “month” and “birthday.” Then, the software will compile a list of addresses of all people whose birthdays fall in that month. Phone lists may also be generated and grouped according to city, country, friends, relatives, colleagues, etc.

The simple searches mentioned above are made possible by entering the information. That is, when entering names and addresses into the software, a user can select options to be connected to each entered name and address. For example, for each name and address entered, a user can select whether Christmas or New Year's greetings are to be sent to that address. Similarly, the month and date of a person's birthday or wedding anniversary can be entered along with their address.

A unique feature of the present invention is that storage of scanned documents of importance, such as passports, wills, house deeds, car ownership certificates, insurance/financial records, receipts of purchases, etc., is allowed. Storage of critical documents of this nature allows one to retrieve the information when the need arises, such as in the unfortunate event of loss by fire, theft, accident, etc. If scanning of documents is done in the alphanumeric format, search and extraction of portions of data from the scanned documents is also possible.

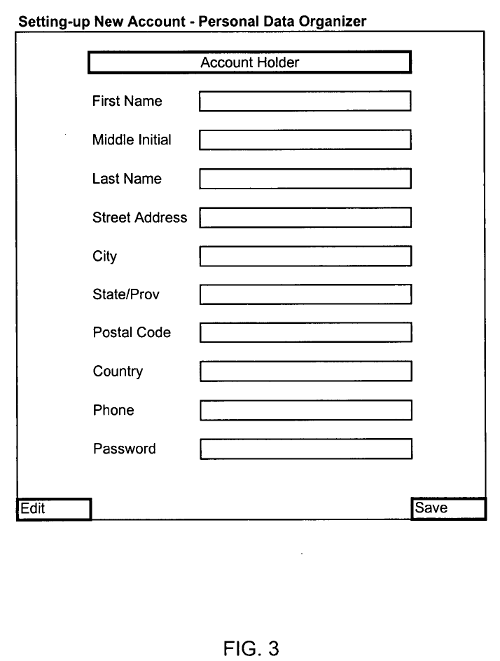

FIG. 1 illustrates a typical view of the Personal Data Organizer Software as seen on a computer screen when the software is opened. Clicking on a tab marked “File” prompts the software to show all of the available options, as illustrated in FIG. 2, which is self-explanatory. Clicking on “Set-up New Account” causes a new window to open, as shown in FIG. 3, and allows a new account to be set up. A user can now create an account by simply filling out the information requested and saving it. The user's account name will simply be the user's name.

To make set up even easier, a setup assistant provides a brief overview of the software's features, asks a few questions, and helps one get up and running in minutes.

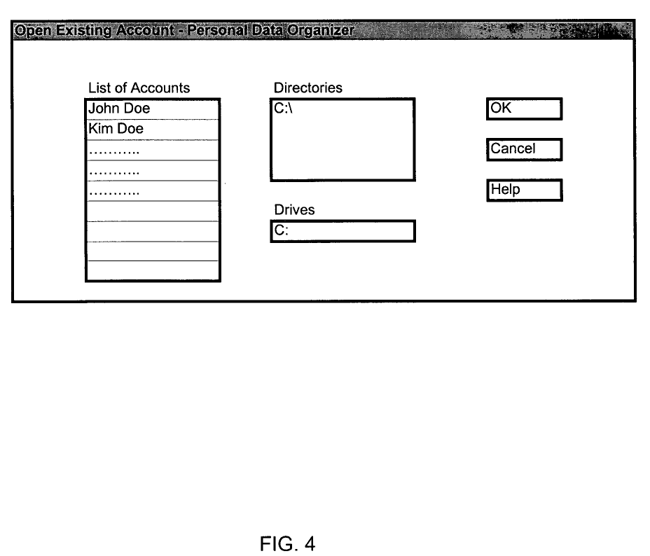

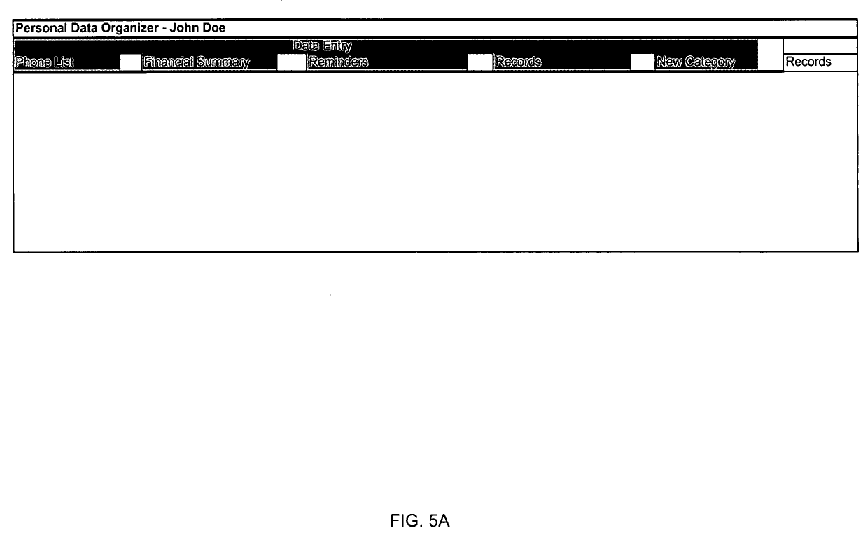

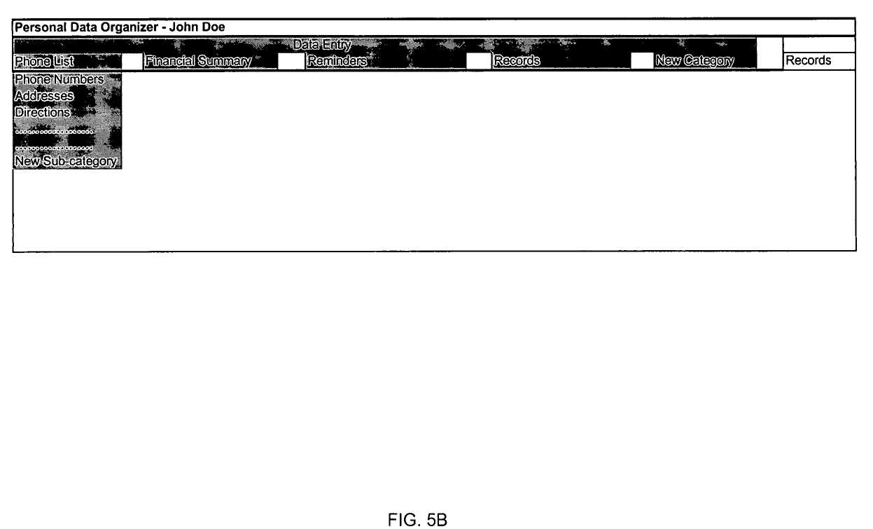

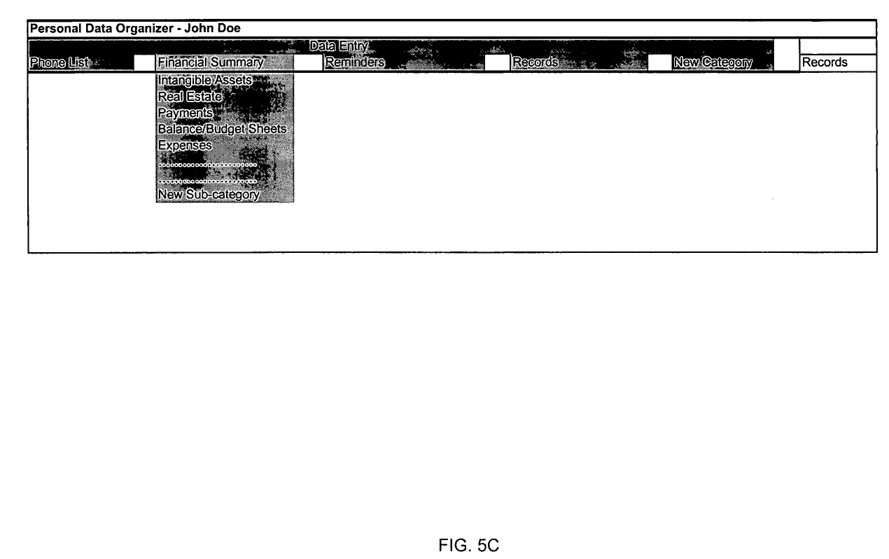

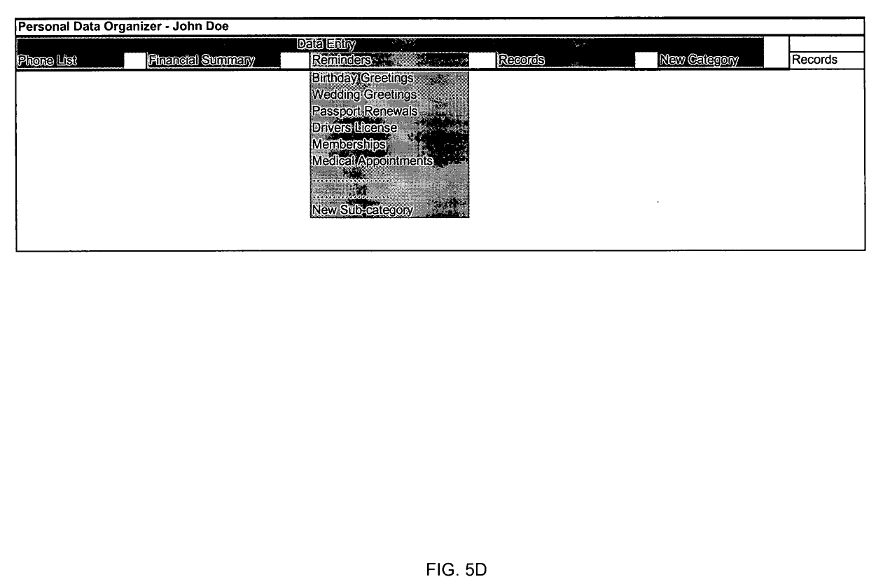

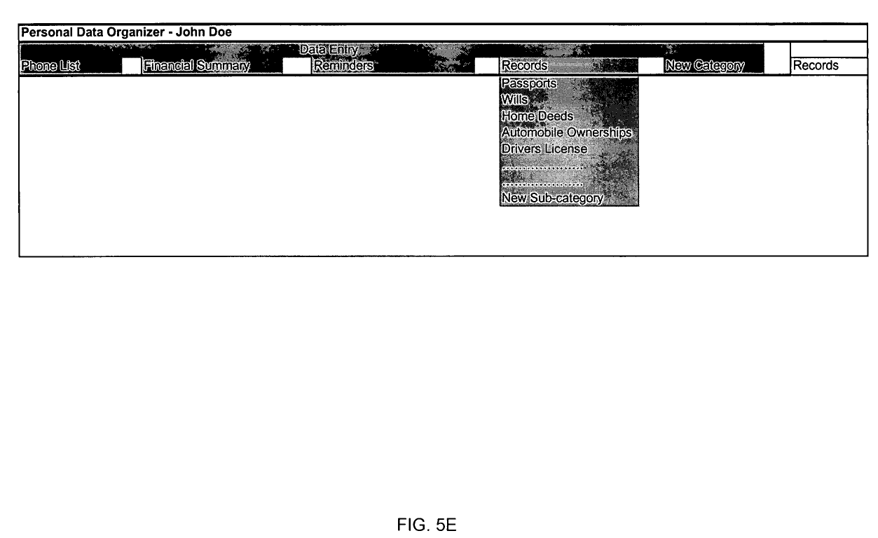

Once a user has created an account, the user can click directly on “Open Existing Account” to open his/her existing account. Clicking on “Open Existing Account” opens a new window as shown in FIG. 4. Whether a user selects “Set-up New Account” or “Open Existing Account,” a new window will open as shown in FIG.5A, which illustrates different types of data that may be entered. A provision is also given to retrieve or view previously entered data by clicking on a tab labeled “Records.” Also, a new data category may be created if any of a user's personal data does not fall into one of the pre-existing categories. Clicking on “New Category” once opens a dialog box in which a name for the new category may be entered. The name of the new category just entered will then be displayed along with the previously existing categories. New categories may be created at any time; there is no software-imposed limit to the number of new categories that may be created.

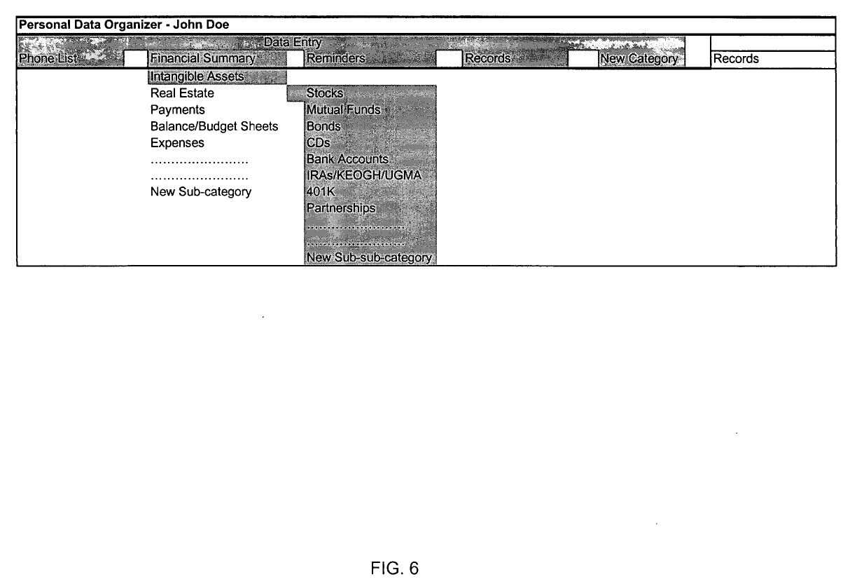

Each category is further subdivided into sub-categories as illustrated in FIGS. 5B to 5E. A provision to add a new sub-category exists for all categories. Where applicable, additional sub-sub-categories exist, such as the “Intangible Assets” sub-sub category shown in FIG. 6.

By the provision for adding new user-defined categories, categories ranging from a retirement home payment schedule for parents and/or dependants to a water-changing schedule for the fish tank may be added. The flexibility and convenience of data organization and retrieval afforded by the software of the present invention are virtually limitless, and can accommodate nearly any requirements of a user that are within the realm of the present invention. Therefore, the flexibility and easy usage of the software package of the present invention may provide an improved quality of life for a user by freeing time and resources of the user.

In addition, “free” entries (entries other than those that have been already defined here) may be added to any category. Addition of free entries to entries in a contact information and directions category may include birthdays, names of spouses and children and their birthdays, and other details. When entering each address, there is a provision for a user to specify if a particular address should be included in a Christmas/New Year's greeting card mailing list or a wedding anniversary/birthday card mailing list. There is another provision that allows a user to specify whether an address should be printed on a mailing label directly. The lists are user defined, preferably by searching on keywords of the list.

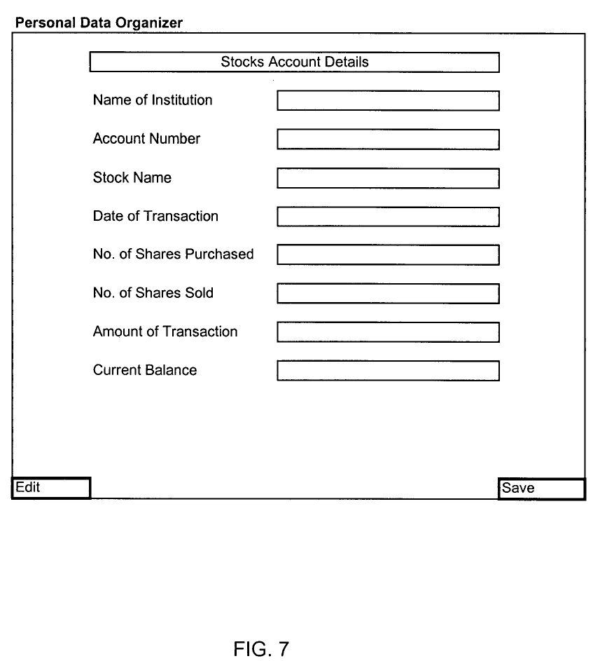

By clicking on “Stocks” shown in FIG. 6, a new window opens, as shown in FIG. 7, which allows one to enter data related to stocks. A similar facility exists for all other sub and sub-sub categories.

In addition, the software package of the present invention includes a search engine that is capable of searching all of a user's personal data upon entry of key words. Therefore, by simply entering an appropriate keyword, a user can retrieve any desired information. That is, data can be identified and grouped according to the needs of a user. For example, data needed for local travel or international travel may be entered or retrieved based on user specified criteria. All information related to a child and all phone numbers of friends in London or California may be identified with similar ease. Further still, by the mere click of a button, maturity dates of CDs or scheduled medical and dental appointments for the next 30 days can be displayed.

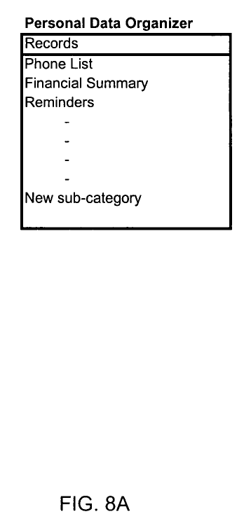

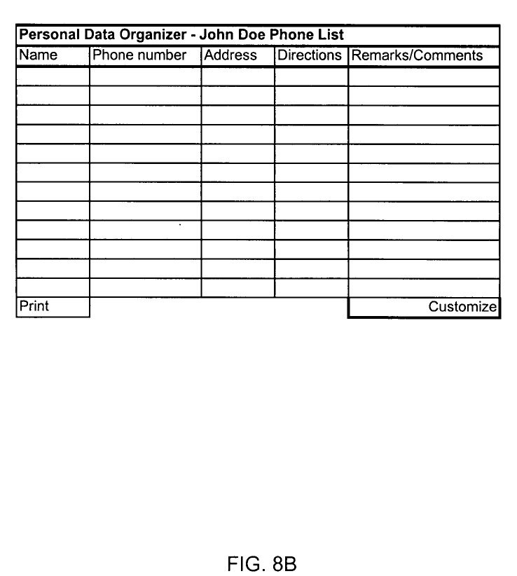

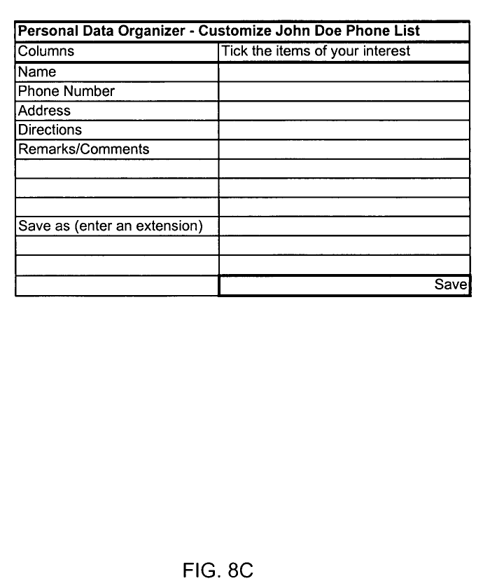

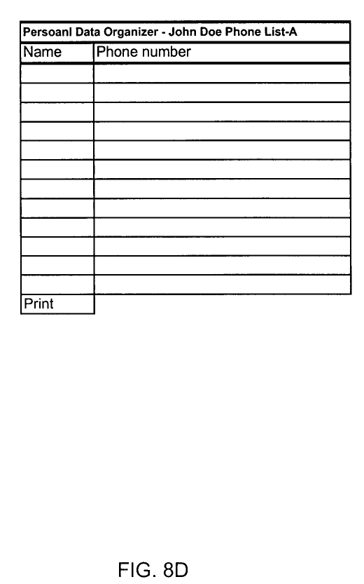

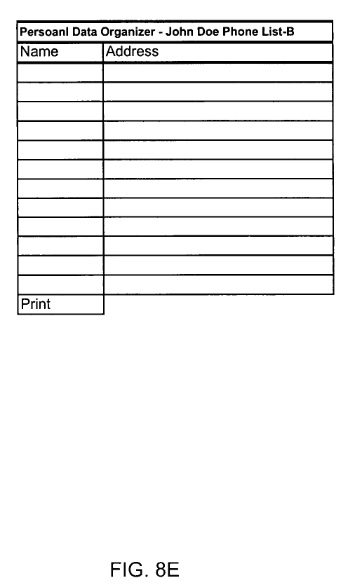

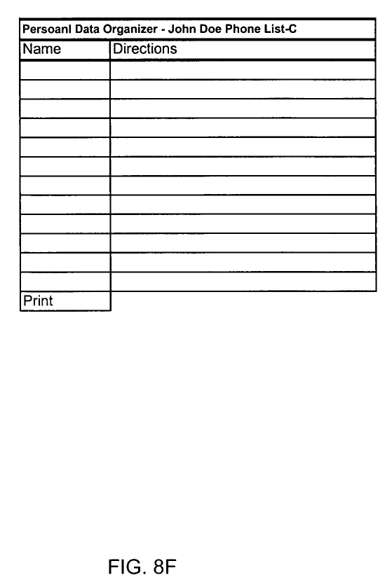

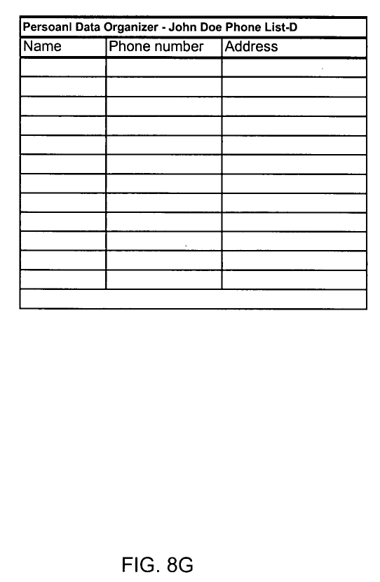

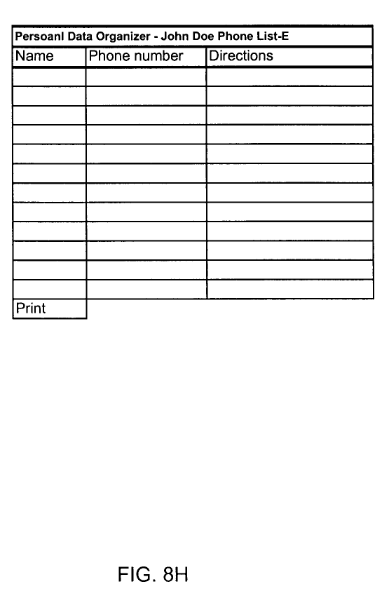

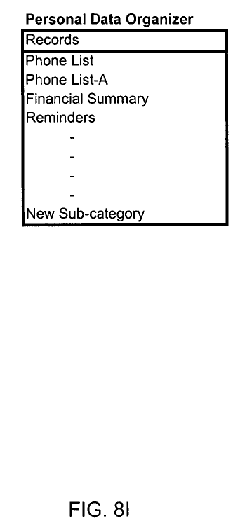

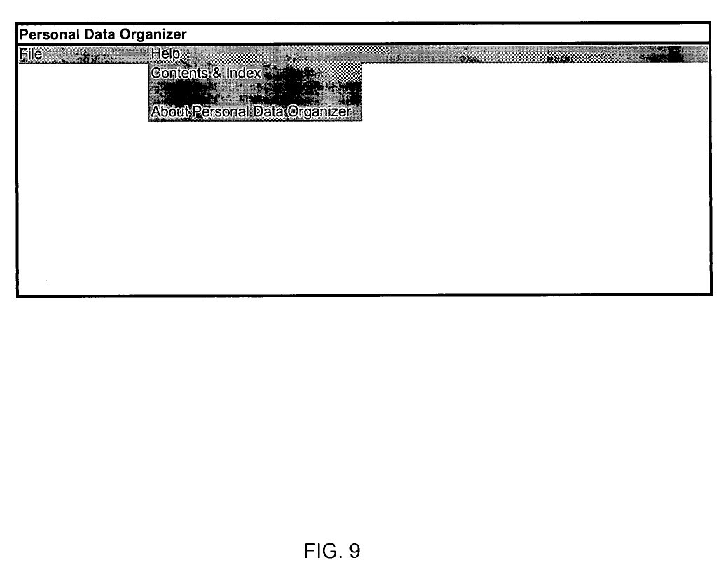

All entered data may be retrieved as “Records.” By clicking on “Records,” a new window opens, as shown in FIG. 8A. For example, if a user clicks on “Phone List,” a new window will open with a default column format containing all “Phone List” data, as shown in FIG. 8B. However, if a customized “Phone List” record is desired, clicking on “Customize” will open another window indicating all “Phone List” options available to be customized, as shown in FIG. 8C. Ticking in the boxes selects preferred columns to appear in the customized record. Data that is not presently needed need not be selected. A user may select only those columns of current interest or need. The thus customized record can be saved with an extension, such as “A.” For example, if the original record is a “Phone List,” the customized record generated from the “Phone List” will be saved as “Phone List-A.” One may customize into a number of formats, some of which are illustrated in FIGS. 8D to 8H. Once customized, the records list will include the customized records along with default records as illustrated in FIG. 8I.

Any other record may be retrieved and customized in a similar manner. If any other record is selected by clicking thereon, a corresponding record with columns of default format will be displayed, and may be customized and saved as a different record with an extension. Any changes made to a user's personal data will immediately be updated in the records.

To locate any particular piece of data, a user simply clicks on “Search” under the “File” menu, which opens a dialog box in which a keyword, i.e., a “word” or “phrase,” may be entered. In response, all records in which the entered “word” or “phrase” appears will be listed.

A provision is provided in the software of the present invention that when enabled, can alert a user in advance of an event such as a birthday, a wedding anniversary, a real-estate tax payment due date, a doctor's appointment, etc. The software of the present invention can remind a user to schedule an annual physical exam or a 6-month dental clean up, send a friend or loved-one an anniversary or Birthday greeting, or can just as easily provide a detailed automobile maintenance schedule for the next five or ten years. The options are virtually limitless.

The software of the present invention includes a “Help” menu as shown in FIG. 1, which provides an index to a number of topics including how to use the software, how to enter data, etc. FIG. 9 illustrates a typical view as seen on a computer screen upon clicking the “Help” menu.

The present invention supports multiple users, with each user being provided a secure environment. Each user is protected by a unique user ID or member name, and a unique password.

Using the single software package of the present invention, all of a family's needs can be categorized and organized. Children can enter schedules, exam dates, due dates, registration deadlines, etc. Heads of household and spouses can enter schedules, appointments, recreation club membership information, club or society meetings, religious or charitable activities, etc. The information can then be viewed and sorted by any combination of criteria, and can be displayed in a variety of formats including plots, charts, graphs and tables. In addition, the information can be saved to a disk or uploaded to a unique website to be easily accessed from any place on earth that Internet access is provided.

The personal data software of the present invention can track changes in financial data and update related categories accordingly. The data can then be displayed in plots, charts, or tables, for example, such that changes are indicated chronologically, or by any other user specified means.

The software also allows one to store scanned passports and other important documents so that even if these documents are lost or stolen, replacement documents may be obtained by furnishing scanned copies of the originals. In addition, scanned and stored receipts, photos and/or appraisals of jewelry, clothing, furniture, etc., may be provided to insurance companies in the event of theft or fire. Further, even video and/or voice recordings can be attached.

The software of the present invention may be utilized by anyone, from a single person with limited assets to a head of household with a large number of assets.

Use of the software of the present invention requires no special training. The software has been consciously conceived and carefully designed to be user friendly, and is therefore easy to learn and use.

The software of the present invention provides an easy way to organize and manage all of one's personal data.

The term “personal data” as used above in the description of the present invention includes, but is not limited to, all of the following categories and equivalents thereof.

(I) A contact information and directions category preferably includes names of individuals, schools, companies, businesses such as banks, organizations including governmental, doctors, dentists, etc., and/or contact persons thereof, all telephone numbers, including home, fax, cellular, etc., at which the occupant of the “name” field may be contacted, all addresses, including e-mail addresses, website addresses, and physical addresses, corresponding to the name and/or phone number(s), and directions to the physical addresses.

(II) Financial Matters:

Assets/Investments: current and cash assets, stocks, mutual funds, government bonds, real estate properties, CDs, savings/checking accounts, partial or entire business ownerships, loans given to others, cash accumulated in whole life or universal life insurance policies, retirement related IRAs, 401Ks, jewelry, household appliances and furnishings and other possessions;

Payments: insurance (professional, health, dental, home, automobile, life, disability, travel, etc.) premiums, mortgage, real estate taxes, home owners association fees, car payments, credit card payments, membership dues, utilities (phone, electricity, gas, water, security alarm system, cable, cell phone), planned religious and charity contributions, alimony, child support, child/elder care;

Income: salary, interest, dividends, rental income, others;

Expenses: household and automobile maintenance, food, gasoline, automobile repair, public/mass transportation, entertainment/vacation, charitable contributions;

balance/budget sheet sub-directory

provision for both monthly and longer duration balance.

data entry for various categories of income such as: salary, interest, dividends, rental income and others.

Financial matters may further include planned savings and investments from the monthly/annual income: 401 K, CDs, stocks, mutual funds, etc.

(iii) Reminders:

birthdays, anniversaries, holidays, special events;

scheduled appointments for dental/medical/physical check-ups, automobile maintenance, etc.;

adult continuing education: course registration, conference and seminar registration, homework and project deadlines;

child related educational and extra-curricular activities such as SAT exam dates, summer camp registration, sports club registration, college/school application deadlines, scouts, projects, paper and homework due dates;

pending renewal dates for professional society memberships, passports, driver's license, automobile registration, club memberships, warranties, magazine subscriptions, household and appliance maintenance contracts; and

facility for reminding in advance (week, month, two-months, etc.) of an event or a due date, which can be entered in a sub-category during data entry.

(iv) Records:

Maintenance of records: wills, trusts, passports, house deeds, automobile ownerships, drivers license, social security card and records, insurance policies, marriage and birth certificates, educational and professional certificates, CD certificates, receipt information of jewelry and other valuables, warranties, etc.

Wills, trusts, passports, house deeds, automobile ownership papers, drivers license, social security card and records, insurance policies, marriage and birth certificates, organ donor information, blood type, educational and professional certificates, CD certificates, receipts of jewelry and other valuables, warranties;

Scanned receipts and/or appraisals for jewelry, clothes, furniture, and other valuables;

Scanned photos of jewelry, passports, warranties and other important documents; and

Voice/Video recordings.

In addition, as previously noted, “free” entries may be added to any category.

Preferred embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A single software package comprising a data entry interface that supports entry of data in multiple formats so that all personal data of a user can be entered into a single personal data file of a single program.

2. The single software package as claimed in claim 1, further comprising a provision by which all of the entered personal data is organized and stored in the single personal data file of the single program.

3. The single software package as claimed in claim 2, further comprising a provision by which organization, storage and retrieval of the entered data are governed by user-defined parameters.

4. The single software package as claimed in claim 1, wherein the data entry interface supports data entered by scanning.

5. The single software package as claimed in claim 1, further comprising pre-defined personal data categories including: a) contact information and directions; b) financial matters; c) reminders; and d) records.

6. The single software package as claimed in claim 5, further comprising pre-defined data sub-categories within each of the categories.

7. The single software package as claimed in claim 6, wherein the sub-categories of the contact information and directions field include:
names of individuals, schools, businesses, private and government agencies, institutions, organizations, facilities, or contact persons thereof;
contact numbers including telephone numbers, cellular phone numbers and fax numbers related to the names;
addresses including e-mail addresses, internet addresses, mailing addresses, and physical addresses related to the names and/or contact numbers; and
directions to the physical addresses.

8. The single software package as claimed in claim 5 further comprising free data categories in which any information related to any contact information and directions entry may be entered, such as family information including names and ages of spouse and children, pertinent dates such as birthdays and anniversaries, and whether the contact information and directions entry should be included in any lists.

9. The single software package as claimed in claim 8, wherein the lists include a Christmas/New Year's greeting card list, birthday/wedding anniversary card list, invitation to event lists and other lists that are user defined.

10. The single software package as claimed in claim 7, in which directions entered by scanning are supported.

11. The single software package as claimed in claim 5, wherein the financial matters category includes:
a) Assets/Investments: current and cash assets, stocks, mutual funds, government bonds, real estate properties, CDs, savings/checking accounts, partial or entire business ownerships, loans given to others, cash accumulated in whole life or universal life insurance policies, retirement related IRAs, 401 Ks, jewelry, household appliances and furnishings and other possessions;
b) Payments: insurance (professional, health, dental, home, automobile, life, disability, travel, etc.) premiums, mortgage, real estate taxes, home owners association fees, car payments, credit card payments, membership dues, utilities (phone, electricity, gas, water, security alarm system, cable, cell phone), religious and charity contributions, alimony, child support;
c) Income: salary, interest, dividends, rental income, others;
d) Expenses: child/elder care, mortgages, household and automobile maintenance, food, gasoline, automobile repair, public/mass transportation, insurance premiums, entertainment/vacation, charitable contributions;

12. The software package as claimed in claim 5, wherein the reminders category includes:
a) Birthdays, anniversaries, holidays, special events;
b) Scheduled appointments for dental/medical/physical check-ups, automobile maintenance,
c) Upcoming renewal dates for professional society memberships, passports, driver's license, automobile registration, club memberships, warranties, magazine subscriptions, household and appliance maintenance contracts;
d) Adult continuing education: course registration, conference and seminar registration, homework and project deadlines; and
e) Child related educational and extra-curricular activities such as SAT exam dates, summer camp registration, sports club registration, college/school application deadlines, scouts, projects, paper and homework due dates.

13. The software package as claimed in claim 5, wherein the records category includes:
a) Wills, trusts, passports, house deeds, automobile ownership papers, drivers license, social security card and records, insurance policies, marriage and birth certificates, organ donor information, blood type, educational and professional certificates, CD certificates, data from receipts of jewelry and other valuables, warranties;
b) Scanned receipts and/or appraisal for jewelry, clothes, furniture, and other valuables;
c) Scanned photos of jewelry, passports, warranties, and other important documents; and
d) Voice/Video recordings.

14. The single software package as claimed in claim 1, further comprising provisions for easy access to and management of the entered personal data.

15. The single software package as claimed in claim 1, further comprising a provision by which an entirety of a user's personal data is searched by performing a single search.

16. The single software package as claimed in claim 1, further comprising a provision for creating new categories, sub-categories, and sub-sub-categories of personal data.

17. The single software package as claimed in claim 1, further comprising a provision to store a user's personal data on a CD or a diskette.

18. The single software package as claimed in claim 1, wherein the entered data can be accessed and viewed in various formats, including lists, tables, graphs, and charts.

19. The single software package as claimed in claim 18, wherein the various formats include Christmas mailing address labels and birthday and wedding anniversary greeting card labels for birthdays and wedding anniversaries occurring in a particular month or any other pre-determined duration.

20. The single software package as claimed in claim 18, wherein the various formats are user defined by selection of categories, sub-categories and/or sub-sub-categories.

21. The single software package as claimed in claim 1, further comprising a provision to alert the user in advance of an event.

22. The single software package as claimed in claim 21, wherein the event includes any of a birthday, wedding anniversary, special event, real-estate tax payment due date, passport renewal, medical/physical check-up, dental check-up, auto maintenance, child related educational or extra-curricular activity such as SAT exam date, summer camp registration, sports club registration, college/school application deadline, scouts, due dates for projects, papers or homework, driver's license renewal, automobile registration renewals, membership renewals or other user defined events.

23. The single software package as claimed in claim 1, further comprising a provision by which multiple users are supported in a safe environment, wherein each user is provided an independent user ID and password.

24. The single software package as claimed in claim 1, further comprising a provision by which a user's personal data file is uploaded to a unique website to allow easy access to the personal data file from anywhere Internet access is provided.

25. The single software package as claimed in claim 11, wherein real estate includes a primary residence, secondary or vacation homes, and investment properties.
